(19) United States
(12) Patent Application Publication
(10) Pub. No.: US 2013/0133582 A1
(43) Pub. Date: May 30, 2013

(54) BIRD FEEDER WITH INNER SHELL

(71) Applicants: Dennis Cheng, Richmond Hill (CA); Teddy Luong, Markham (CA)

(72) Inventors: Dennis Cheng, Richmond Hill (CA); Teddy Luong, Markham (CA)

(73) Assignee: Umbra LLC, Buffalo, NY (US)

(21) Appl. No.: 13/308,009

(22) Filed: Nov. 30, 2011

(51) Int. Cl. A01K 39/01; A01K 39/014

(52) U.S. Cl. 119/52.2; 119/51.01

(57) ABSTRACT

The present invention is a bird feeder that includes a base with a perimeter surrounding a floor, the floor having a raised center portion and at least one sloping portion extending to the perimeter; an edge attached to and extending from the perimeter; a plurality of risers extending from the perimeter at least partly up the at least one sloping portion toward the raised center portion. The subject bird feeder also includes an outer shell having at least one outer wall and supported by the plurality of risers; an inner shell having at least one inner wall and shaped to fit closely inside the outer shell; and, a removable lid shaped to cover the top of the outer shell. The outer shell may include cutouts that extend through the walls. The inner shell may be transparent. The bird feeder may also include a cord to allow it to be hung.

### FIELD OF THE INVENTION

The present invention relates generally to the field of bird feeders, more particularly to hanging or suspended bird feeders, and still more particularly to decorative hanging or suspended bird feeders in which the level of bird seed or bird food in the feeder is visible to a user.

### BACKGROUND OF THE INVENTION

Bird feeders are well known and are used by people not only to provide a food supply for birds, but also to actually view birds in a natural habitat. Often bird feeders are located in private yards or other locations in which it is often important to not only have a bird feeder that efficiently provides food to birds, but also is easy to use and provides a decorative element to its setting.

Many bird feeders are made of metal or other opaque materials often making it difficult to monitor the level of feed remaining in the feeder. Moreover, such feeders often lack the aesthetic appeal appropriate for enhancing the bird-watching experience in locations such as private yards. This can be especially true for metal or wooden feeders which deteriorate due to weather conditions. In addition, with metal or wooden bird feeders it is frequently difficult to determine how much food remains in the feeder to replenish it in a timely manner.

Thus, there is a need in the field for a bird feeder that is aesthetically pleasing, durable, and easy to monitor for refilling.

### SUMMARY OF THE INVENTION

The present invention broadly comprises a bird feeder comprising a base including a perimeter surrounding a floor, in which the floor has a raised center portion and at least one sloping portion extending to the perimeter; an edge attached to and extending from the perimeter; a plurality of risers extending from the perimeter at least partly up the at least one sloping portion toward the raised center portion. The subject bird feeder also includes an outer shell having at least one outer wall and supported by the plurality of risers; an inner shell having at least one inner wall and shaped to fit closely inside the outer shell; and, a removable lid shaped to cover the top of the outer shell.

In a preferred embodiment, the outer shell includes cutouts that extend through the walls of the outer shell while the inner shell is transparent. In another preferred embodiment, the bird feeder also includes a cord to allow it to be hung or suspended.

One object of the invention is to provide a bird feeder that is durable in an outdoor environment.

A second object of the invention is to present a bird feeder that is easily monitored for refilling purposes.

A third object of the invention is to supply a bird feeder that is decorative.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a top perspective view of the decorative bird feeder of the present invention;

FIGS. 2-5 are respectively front, rear, left, and right side views of the bird feeder of the present invention;

FIG. 6 is a top view of the bird feeder;

FIG. 7 is a bottom view of the bird feeder of the present invention;

FIG. 8 is a cross section view of the bird feeder taken along line 8-8 in FIG. 4;

FIG. 9 is an enlarged view of the circled area 9 seen in FIG. 8;

FIG. 10 is a close up view of one corner of the outer shell supported by one of the plurality of risers;

FIG. 11 is an enlarged view of the circled area 11 seen in FIG. 8; and,

FIG. 12 is an exploded perspective view of bird feeder.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

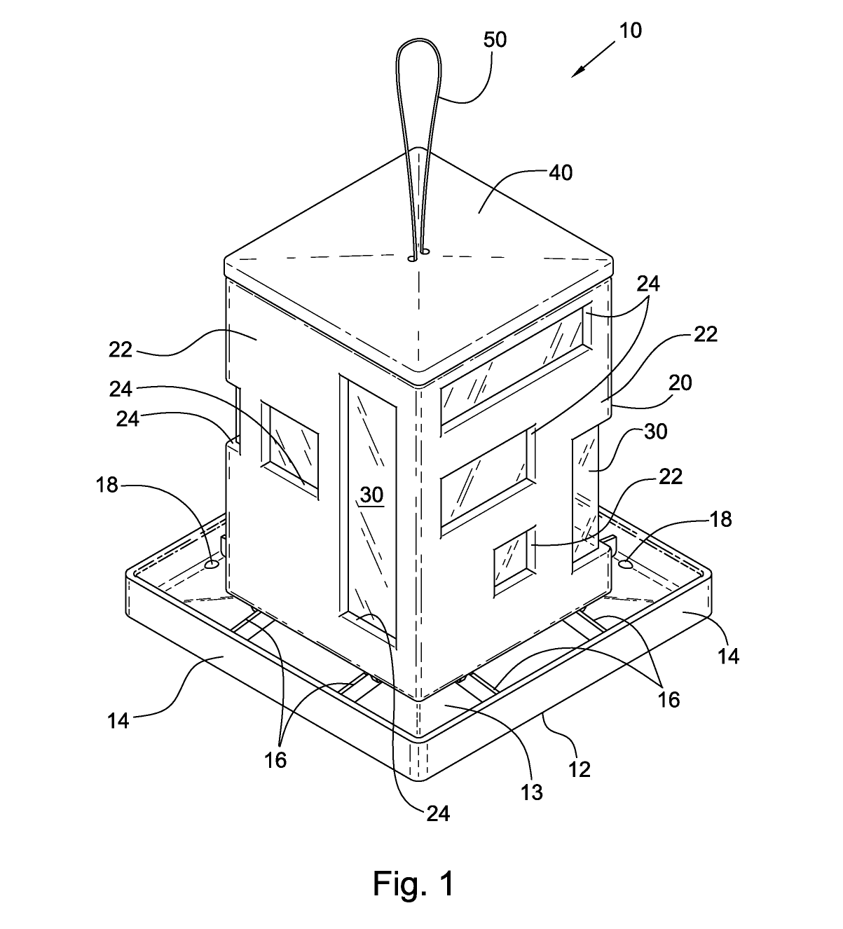

Adverting to the drawings, FIG. 1 is a top perspective view of the decorative bird feeder 10 (“feeder 10”) of the present invention. Base 12 supports outer shell 20. Inner shell 30 is enclosed by outer shell 20 and lid 40 and is supported by base 12 as described below. Preferably, inner shell 30 is transparent and fabricated from a suitable plastic, such as ABS. Outer shell 20 and inner shell 30 each comprises at least one wall 22 and 32, respectively, in which inner shell 30 fits into outer shell 20. In the view in FIG. 1, both outer shell 20 and inner shell 30 include four walls, but persons of skill in the art will recognize that they may include a single cylindrical wall or a number of connected walls forming a polygon. In the preferred embodiment, inner shell 30 is configured to fit closely inside outer shell 20 but is easily removed if desired. By shaped is meant to adapt in shape so as to fit neatly and closely. By “closely” is meant having little space between items or units. Cord 50 is attached to feeder 10 and extends through lid 40 to enable feeder 10 to be hung or suspended as desired. Cord 50 may be fabricated from any suitable material including metal cable, rope, string, wire, etc.

Outer shell 20 includes a plurality of cutouts 24 which extend through outer shell wall(s) 22 to form openings which are defined by outer shell wall(s) 20. Although the cutouts 24 may be spread to any location on outer shell wall(s) 22, in a preferred embodiment, they are distributed around outer shell 20 so they may be viewed from any direction. As seen in FIG. 1, one or more of cutouts 24 may be positioned over more than one side of a multi-walled outer shell 20. The close fit of the walls 32 of inner shell 30 provide an inside “cover” of cutouts 24 that prevents entrance of rain, snow, and small animals into the chamber enclosed by inner shell 30.

A plurality of risers 16 extends up from the floor 13 of base 12 and support outer shell 20. Risers 16 are preferably distributed evenly and extend at least partly from edge 14 at the perimeter of base 12 toward the center of base 12. As described below, floor 13 includes a raised center portion 13c and at least one slope 13b, meaning that risers 16 extend at least partly up slopes 13b and other slopes if present. Apertures 18 are located at the perimeter of base 12 at the junction of edge 14 and slopes 13b and other slopes if present. Apertures 18 act as drains to prevent rainwater and other forms of moisture from collecting on base 12.

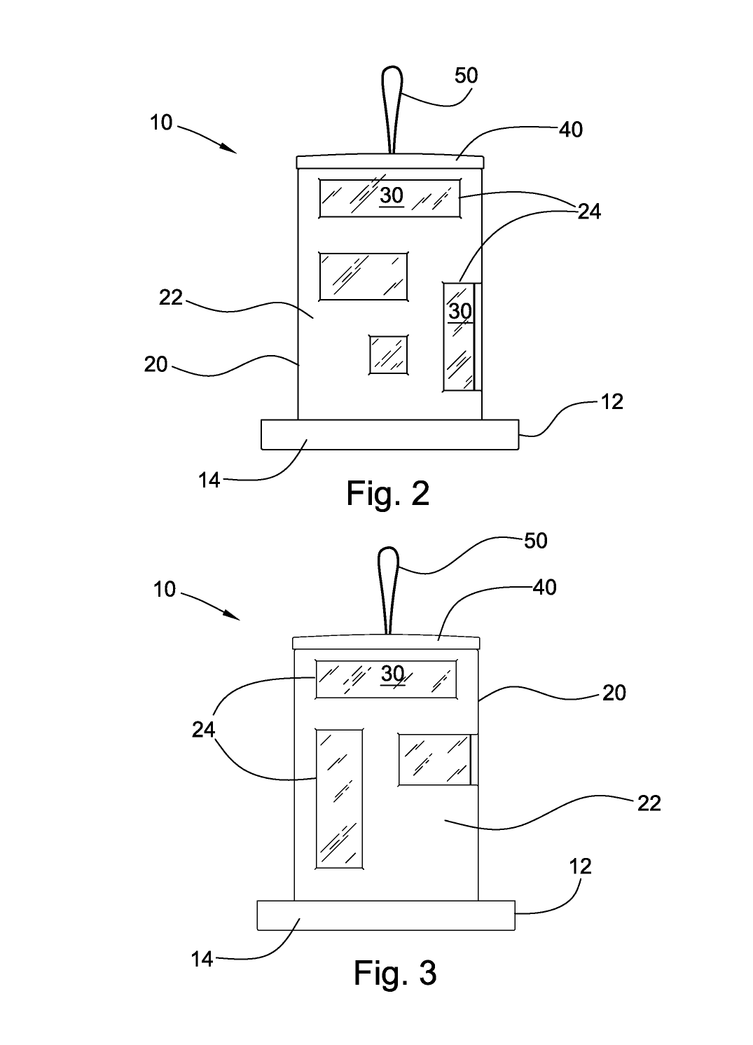

FIGS. 2-5 are respectively front, rear, left, and right side views of feeder 10. It can be seen that the length of each one of the plurality of cutouts 24 together extend most of the length of outer shell 20. Thus, in the preferred embodiment in which inner shell 30 is transparent, bird seed or other similar bird food may be loaded into feeder 10. As the bird seed is depleted, the drop in the level of the bird seed can be observed through the various cutouts 24 at their locations on outer shell 30. Thus, inner shell 30 holds the bird seed in feeder 10 while the level of bird seed within feeder 10 can be seen through the transparent window formed by cutouts 24 and transparent shell 30.

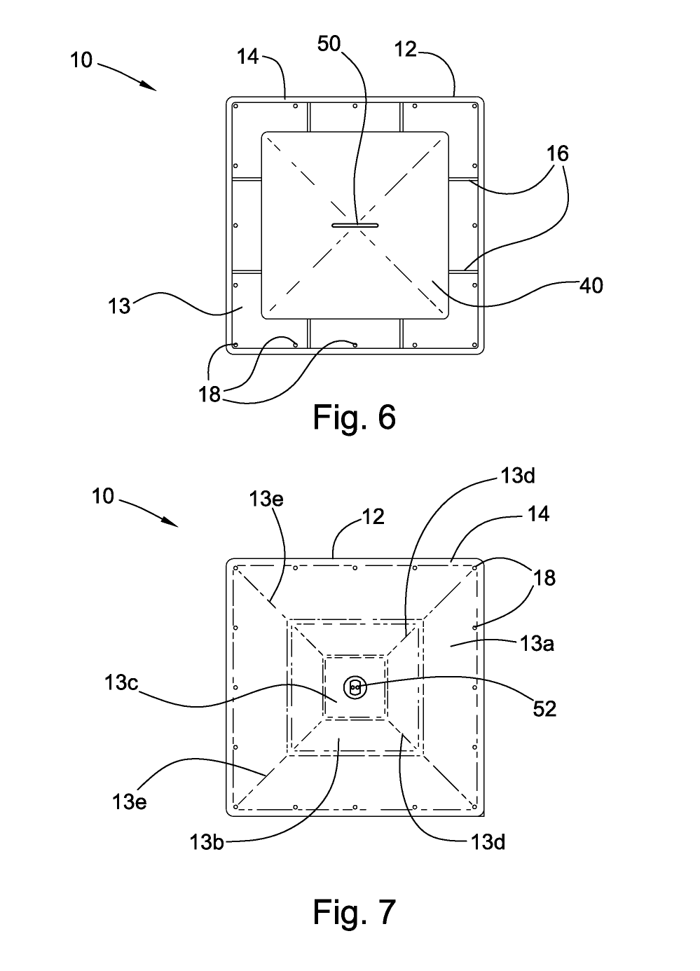

FIG. 6 is a top view of bird feeder 10. FIG. 6 depicts a preferred embodiment in which lid 40 is slightly tapered toward all of its edges to prevent or at least restrict pooling of water on the lid. Risers 16 can be seen distributed evenly around base 12 and extending from edge 14. Risers 16 can be used to divide base 12 into separate feeding compartments as bird seed falls down slope(s) 13b and 13a. FIG. 7 is a bottom view of bird feeder 10. This bottom view depicts the shape of floor 13 of base 12. Raised center portion 13c is in the center and may be relatively flat although this is not required. Floor 13 includes at least one first slope 13b that extends from center portion 13c. In the embodiment shown, corners 13d and 13e are formed between each of upper first slopes 13b and second slopes 13a. In other embodiments a single slope without corners may be utilized or a first slope 13b may extend from center portion 13c to the perimeter of base 13 and edge 14. Fastener 52 holds cord 50 to feeder 10.

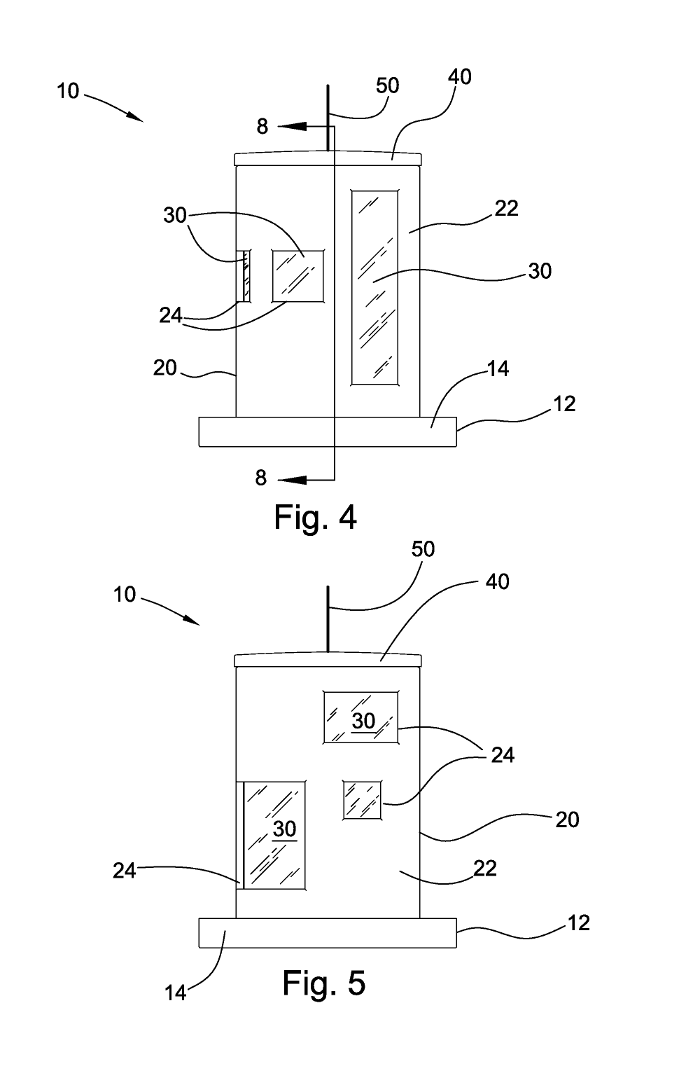

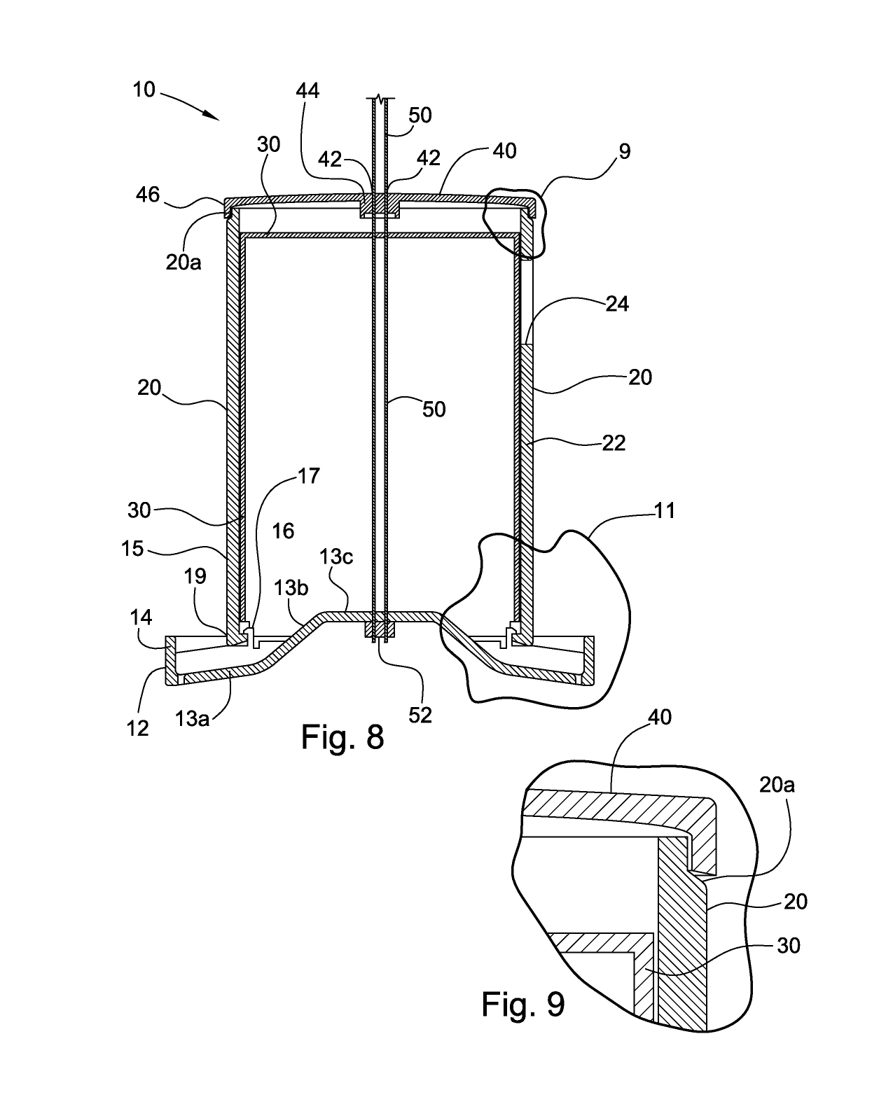

FIG. 8 is a cross section view of feeder 10 taken along line 8-8 in FIG. 4. Cord 50 is seen extending from above lid 40 through two holes 42 and reinforcement 44 through the space defined by inner shell 30 and then fastened below center portion 13c at fastener 52. Persons of skill in the art will recognize that cord 50 may be fastened using several different fasteners. While several different materials may be used to fabricate the cord, in one preferred embodiment, a stiff wire or cable is used to keep cord 50 stiff when feeder 10 is not hanging or suspended.

As seen in FIG. 8, lid 40 is removably fitted over outer shell 20 with lip 46 forming a friction fit with shoulder 20a of outer shell 20. This is more easily seen in FIG. 9 which is an enlarged view of the circled area 9 seen in FIG. 8. FIG. 9 also demonstrates the small gap between outer shell 20 and inner shell 30 forming the close fit described above.

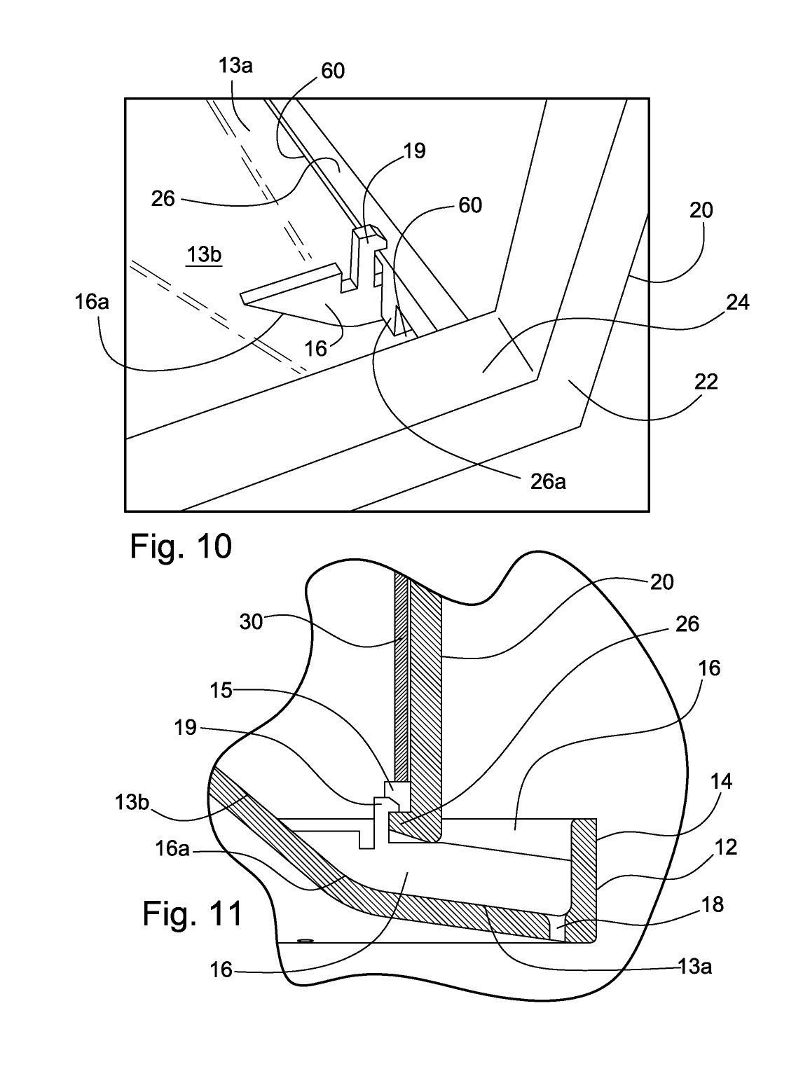

FIG. 10 is a close up view of one corner of outer shell 20 supported by one of the plurality of risers 16. Clip 19 extends from riser 16 and holds lip 26 of outer shell 20. Preferably, clip 19 is integral with riser 16. Preferably, clip 19 fixedly secures lip 26 with a snap fit. Riser 16 includes sloping bottom surface 16a with a grade(s) that conforms to the slope of first slope 13b and second slope 13a. By conforms is meant that the grade of bottom surface 16a matches the angle of slopes 13b and 13a so that bottom surface 16a rests on first slope 13b and second slope 13a for most or all of its length. Gap 60 is the space between the bottom of outer shell 20 formed by lip 26 and first slope 13a. Gap 60 and first slope 13b and second slope 13a cooperate to allow bird seed to flow down the slope and out the gap into the compartments formed by risers 16. Extension 26a is present to ensure gap 60 is formed if a riser breaks or is not present by resting on second slope 13a.

FIG. 11 is an enlarged view of the circled area 11 seen in FIG. 8. This figure provides a different view of the snap fit of clip 19 holding lip 26 of outer shell 20. Also seen is the conformance of the grade of bottom surface 16a to the angles of slopes 13b and 13a as well as apertures 18 providing drains on floor 13 of base 12. Also seen is post 15 which may be located on lip 26 and in the corners inside outer shell 20. In one embodiment, posts 15 are integral with outer shell 20. Posts 15 support inner shell 30 above lip 26. Posts 15 may be located on the corner of shell 20 and/or along lip 26.

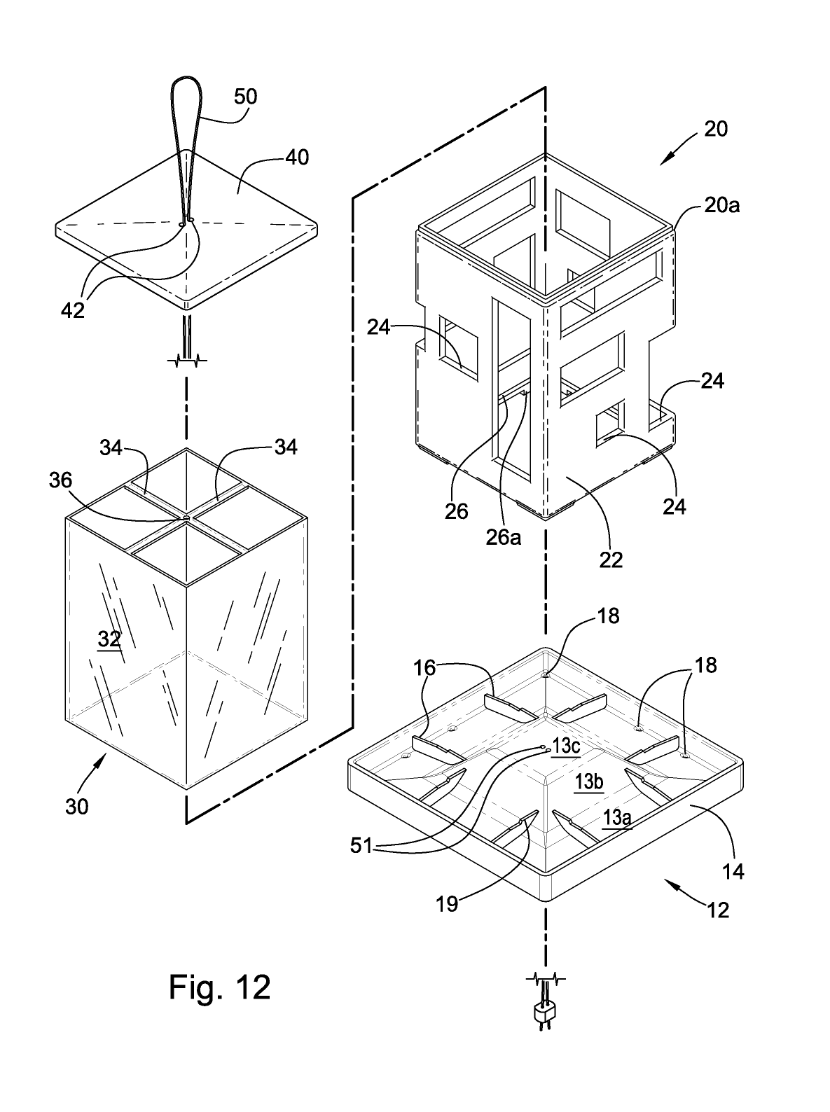

FIG. 12 is an exploded perspective view of bird feeder 10. Floor 13 includes center raised portion 13c and upper first slope 13b that inclines toward each edge 14 of base 12 from center raised portion 13c. In the embodiment shown, first slope 13b leads downwardly to second slope 13a which ends at edge 14 at the perimeter of base 12. In an alternate embodiment, first slope 13b alone will extend to the perimeter of base 12. Holes 51 in center rotation 13c receive cord 50 which can be fastened under base 12 as discussed above. Outer shell 20 fits onto base 12 and is secured by a snap fit connection using clips 19 that hold lip 26. Inner shell 30 fits closely inside outer shell 20 and rests on posts 15 (not seen in FIG. 12) such that the bottom edge of inner shell 30 rests above lip 26. The close fit allows inner shell 30 to cover cutouts 22 on the inside of inner shell 20 to prevent rain and other environmental elements from affecting the bird seed inside inner shell 30.

Inner shell 30 includes cross pieces 34 with holes 36. Cross pieces 34 provide stability for the inner shell 30 structure and are used to define holes 36 which receive cord 50 allowing cord 50 to extend through the interior of feeder 10. Lid 40 covers feeder 10 by a frication fit with outer shell 20 at shoulders 20a.

Bird seed or other food is added to feeder 10 by removing lid 40 and adding the food inside inner shell 30. The transparent inner walls 32 allow the user to determine the amount of food in feeder 10 by observing the food level through cutouts 24 and transparent inner wall 32. In the preferred embodiment discussed above, cutouts 24 are situated on outer wall 22 so that the level can be observed as it falls along most if not all of the length of feeder 10.

As food falls to base 12, it reaches floor 13. If it rests on raised center portion 13c, it will fall down slopes 13b and 13a from raised center portion 13c in all directions toward the perimeter of base 12 where flow is stopped by edge 14. Gap 60 discussed above allows the food to flow from inside inner shell 30 and outer shell 20 to the outside compartments formed by risers 16. This allows access to birds and allows for gradual replacement of the food as it is used by birds or other animals.

Thus it is seen that the objects of the invention are efficiently obtained, although changes and modifications to the invention should be readily apparent to those having ordinary skill in the art, which changes would not depart from the spirit and scope of the invention as claimed.

We claim:

1. A bird feeder comprising:
a base including;
a floor with a surrounding perimeter, said floor having a raised center portion and at least one sloping portion extending to said perimeter;
an edge extending from said perimeter;
a plurality of risers extending from said perimeter at least partly up said at least one sloping portion toward said raised center portion;
an outer shell having at least one outer wall and supported by said plurality of risers;
an inner shell having at least one inner wall and shaped to fit closely inside said outer shell; and,
a removable lid shaped to cover the top of said outer shell.

2. The bird feeder as recited in claim 1 further comprising at least one drain hole in said base.

3. The bird feeder as recited in claim 1 further comprising a hanging cord attached to said bird feeder and extending through said removable lid.

4. The bird feeder as described in claim 1 wherein said outer shell defines a plurality of cutouts cut through at least one of said at least one outer wall.

5. The bird feeder as recited in claim 1 wherein said inner shell is transparent and covers at least one of said plurality of cutouts.

6. The bird feeder as recited in claim 1 wherein at least one of said plurality of risers includes a clip, said clip forming a snap fit to fixedly secure said outer shell.

7. The bird feeder as recited in claim 1 further comprising a plurality of stops, said plurality of stops supporting said inner shell.

8. The bird feeder as recited in claim 1, wherein said outer shell and said inner shell are each cylindrical.

9. The bird feeder as recited in claim 1 wherein said at least one wall of said outer shell and said inner shell each forms a polygon.

10. The bird feeder as recited in claim 9 wherein said polygons each comprise four walls having equal length and width.

11. The bird feeder as recited in claim 1 wherein said risers form compartments in said base.

12. The bird feeder as recited in claim 1 wherein said at least one slope is two slopes each of said two slopes having different angles.

13. A bird feeder comprising:
a base including;
a floor with a surrounding perimeter, said floor having a raised center portion and at least one sloping portion extending to said perimeter;
an edge extending from said perimeter;
a plurality of risers extending from said perimeter at least partly up said at least one sloping portion toward said raised center portion;
an outer shell having at least one outer wall and supported by said plurality of risers, wherein said outer shell defines a plurality of cutouts cut through each of said at least one outer wall;
an inner shell having at least one inner wall and shaped to fit closely inside said outer shell, wherein said inner shell is transparent and covers at least one of said plurality of cutouts;
a removable lid shaped to cover the top of said outer shell;
at least one drain hole in said base; and,
a hanging cord attached to said bird feed and extending through said removable lid.

14. The bird feeder as recited in claim 13 wherein at least one of said plurality of risers includes a clip, said clip forming a snap fit to fixedly secure said outer shell.

15. The bird feeder as recited in claim 13 further comprising a plurality of stops, said plurality of stops supporting said inner shell.

16. The bird feeder as recited in claim 13, wherein outer shell and said inner shell are each cylindrical.

17. The bird feeder as recited in claim 13 wherein said at least one wall of said outer shell and said inner shell each forms a polygon.

18. The bird feeder as recited in claim 17 wherein said polygons each comprise four walls having equal length and width.

19. The bird feeder as recited in claim 13 wherein said risers form compartments in said base.

20. The bird feeder as recited in claim 13 wherein said at least one slope is two slopes each of said two slopes having different angles.
